(19) United States
(12) Patent Application Publication
(10) Pub. No.: US 2009/0217207 A1
(43) Pub. Date: Aug. 27, 2009

(54) DISPLAY OF A MEDICAL IMAGE

(76) Inventors: Robert Kagermeier, Nurnberg (DE); Eike Fietzel, Darmstadt (DE); Steffen Schroter, Furth (DE); Dietmar Sierk, Erlangen (DE)

Correspondence Address: BRINKS HOFER GILSON & LIONE, P.O. BOX 10395, CHICAGO, IL, 60610, US

(21) Appl. No.: 12/372,278

(22) Filed: Feb. 17, 2009

(30) Foreign Application Priority Data
Feb. 22, 2008 (DE) DE102008010 717.4

(51) Int. Cl. G06F 3/048; G01P 15/00; G06F 3/033

(52) U.S. Cl. 715/850; 73/488; 345/158

(57) ABSTRACT

A device for displaying a medical image is provided. The device includes a processing unit, a display, a remote control, a communication interface, and a software module. The processing unit is operable to process the medical image information. The display is operable to display the medical image information. The remote control is operable to register a user movement by at least one motion-sensitive sensor. The communication interface is operable to transfer the user movement to the processing unit. The software module is associated with the processing unit. The software module is operable to reconcile the user movement with the medical image information so that the user movement is reproduced as a virtual movement of the displayed medical image information.

This patent document claims the benefit of DE 10 2008 010 717.4, filed Feb. 22, 2008, which is hereby incorporated by reference.

### BACKGROUND

The present embodiments relate to displaying a medical image. In particular, the present embodiments relate to a device, method, and imaging system for displaying a medical image.

Imaging systems are available for generating medical image information. The imaging systems include for example a Computer Tomograph (CT), a Positron Emission Tomograph (PET), a Single Photon Emission Computed Tomograph (SPECT) or a Magnetic Resonance Tomograph (MRT). The imaging system is used to obtain an image of a body region of a person. Medical image information includes image information that can be obtained using the imaging system. The image in question is normally a two-dimensional (2D), three-dimensional (3D) or four-dimensional (4D) image. A two-dimensional image encompasses two spatial dimensions. A three-dimensional image encompasses three spatial dimensions or two spatial dimensions and the time. A four-dimensional image encompasses three spatial dimensions and the time. The time as a dimension is of significance in the situation when images of a body region are recorded at different points in time. During cardiology, when investigating the heart of a patient for a possible malfunction, image information for different heart phases, which are provided with a time stamp for investigation purposes, are recorded.

The image information is displayed on a display, such as a monitor. By using the image information displayed it is possible to produce a medical interpretation relating to the corresponding body region. The displayed image information makes it possible to monitor a medical intervention by using the imaging system to measure an image from time to time while the medical intervention is being performed, which is then interpreted by the doctor.

The preparation and display of the information for the images are carried out by using a processing unit associated with the imaging system, which may be a computer system. It is possible to use a control device, such as a computer keyboard or a computer mouse, to change the image information displayed on the display. A software module enables the selection of different functions, such as a detail enlargement of the image information, a rotation of the image information or other similar function, by way of the control device. The actual modification of the display is subsequently performed by the cursor keys on the computer keyboard or by scrolling with the computer mouse. A desk or similar support structure is required as a support for the computer keyboard or for the computer mouse. As a result, the computer keyboard or the computer mouse may not be positioned in the immediate service area of a patient positioning device, such as a patient examination table, on which the patient is positioned for the medical examination or intervention. When performing a medical intervention, the doctor constantly switches between the patient positioning device and the location of the control device in order to be able to appraise the progress of the medical intervention.

### SUMMARY AND DESCRIPTION

The present embodiments may obviate one or more of the drawbacks or limitations inherent in the related art. For example, in one embodiment, a device allows displayed image information to be modified in a simple user-friendly manner.

In one embodiment, a device for providing medical images is provided. The device includes a processing unit for processing image information and a display for displaying the image information. The processing unit may be a computer system, with which is associated a display taking the form of a monitor. The device may include a remote control that registers a user movement by at least one motion-sensitive sensor. A communication interface may transfer the user movement to the processing unit. Associated with the processing unit is a software module for reconciling the user movement with the image information. This reconciliation takes place in such a manner that the user movement is reproduced as a virtual movement of the displayed image information on the display. A user movement may be converted in intuitive fashion into a similar movement of the image information on the display element. A support for the remote control, such as a desk, is no longer required. A doctor may carry the remote control and make a change in the displayed image information from any location in the vicinity of the imaging system. When the display is of an adequate size, the doctor performing a medical intervention no longer needs to constantly change his location in order to assess the progress of the medical intervention on the basis of the image information. A medical intervention may be performed more quickly; and thus, with less stress for the patient.

In one embodiment, the sensor is an acceleration sensor with one or more measuring axes. U.S. Pat. No. 5,540,095 describes an acceleration sensor. The acceleration sensor may register a translatory movement of the remote control as a user movement. When the acceleration sensor includes three measuring axes, a movement of the remote control in any of the three spatial directions may be registered. The user movement is converted into a corresponding translatory movement of the image information on the display.

In one embodiment, the sensor is a rotary rate sensor or gyroscope with one or more measuring axes. U.S. Pat. No. 6,505,511 B1 describes a rotary rate sensor. The rotary rate sensor may register a rotational movement or rotation of the remote control as a user movement, which is reproduced as a rotational movement or rotation of the displayed image information. When the rotary rate sensor is a three-axis rotary rate sensor, then any desired rotation of the remote control can be registered by it as a user movement and reproduced as a virtual movement of the displayed image information.

In one embodiment, the remote control has at least one acceleration sensor and at least one rotary rate sensor. When the two sensors are three-axis sensors, any desired movement of the remote control in the room can be registered by the two sensors as a user movement and reproduced as a virtual movement of the displayed image information. As a result, a completely intuitive change in the image information displayed on the display is possible.

In one embodiment, a radio link is provided as a communication interface. The radio link enables a wireless transmission of the user movement to the processing unit. As a result, a doctor carrying out the interpretation does not have his freedom of movement restricted in any way, as would be the case with a cable connection as the communication link between the remote control and the processing unit.

In one embodiment, the remote control has a number of display selection switches for selecting a display mode in each case. The user movement is converted into the virtual movement of the image information as a function of the display mode selected. A user movement may be only converted into a movement of the displayed image information if a corresponding display selection switch has previously been actuated. Any accidental alteration of the displayed image information as a result of unintentional movement of the remote control and an undesired registration of a movement as a user movement are thus reliably avoided.

In one embodiment, the remote control has at least one control selection switch for remotely controlling a medical diagnostic or therapeutic unit. Functions of the medical diagnostic or therapeutic unit can be activated by the remote control. For example, in the context of obtaining medical information, the recording of a new image may be initiated in order to render visible the progress of the medical intervention in the form of image information. In the case of an X-ray therapeutic unit it is, for example, possible to turn on or turn off a therapeutic radiation process, such as an X-ray radiation process or a particle radiation process, for the specific radiation treatment of a patient. Medical interventions may be imitated by the remote control. For example, a contrast agent may be injected or a thermal or electrical therapy technique may be initiated using the remote control. An implantation by the preformed by the remote control, for example of a seed in brachytherapy or of a stent in the case of an intervention on a heart.

In a one embodiment, a holding device is provided for holding the remote control in a rest position. This holding device is arranged, for example, on a rail of a patient positioning device taking the form of a patient examination table. The holding device holds the remote control in such a way that the doctor has both hands free in order to perform an intervention. Since the holding device can be arranged on the patient positioning device or in its immediate vicinity, the remote control is always within the reach of the doctor.

The holding device may include an elastic mounting. The remote control held by the holding device continues to be moveable, with restrictions where applicable. The remote control does not therefore need to be specially removed from its holding device in order to perform simple movements. Rather, after executing the movement, the doctor immediately has his hands free again in order to continue the medical intervention.

In one embodiment, a method for displaying a three-dimensional medical image is provided. The method may include registering a user movement using a remote control by at least one motion-sensitive sensor. The user movement is then transferred by a communication interface to a processing unit. The user movement is reproduced as a virtual movement of the displayed image information. In this connection, the variants based on the device for displaying a three-dimensional medical image, and their advantages, are to be applied by analogy to the method.

A display mode provides for a selection and a displacement in at least one spatial direction of an enlarged image section from the image information. Only the translatory movement of the remote control is registered by the acceleration sensor. The selection of the display mode is performed by a display selection switch which takes the form, for example, of a pushbutton. In this situation, when the display mode is activated an image section, the central image section of the image information displayed on the display element, may be initially represented enlarged. A displacement of this image section can then be effected by the user movement until the image information of interest is represented in enlarged form in the image section. Repeated successive actuations of the corresponding display selection switch enable a stepwise change in the image section and a graduated enlargement of the displayed image information.

Different functions may be combined with one another. In the case of a two-dimensional (2D) image, a movement of the remote control in one plane may be interpreted as a change in the image section and a movement upwards or downwards from the viewpoint of the plane may be interpreted as an enlargement or reduction in size respectively of the displayed image information.

A display mode provides for a rotation of the displayed image information around at least one spatial axis. Only the rotational movement of the remote control may be registered by rotary rate sensor. The displayed image information can be rotated until such time as the image information of interest is easily visible on the display element and can thus be interpreted.

A display mode provides for a change in the scale of the displayed image information. The displayed image information is enlarged or reduced in size steplessly (intervally) through a translatory movement or through a rotational movement of the remote control.

A display mode provides for a change in the contrast of the displayed image information. The contrast may be increased or reduced steplessly through a translatory movement or through a rotational movement of the remote control. The grayscale of an image displayed as a grayscale image may be steplessly adjusted. The grayscale may include 255 gray values. The best possible contrast for an interpretation may be presented in a simple manner.

In one embodiment, a display mode utilizes the measurements taken with the acceleration sensor and with the rotary rate sensor jointly in order to change the displayed image information. Different options may be used for changing the image information.

In the case of a three-dimensional (3D) image, the displayed image section may be displaced with a translatory movement and an enlargement or reduction in size of the displayed image information may be performed by rotating the remote control. In this situation, a counterclockwise rotation of the remote control can for example result in an enlargement and a clockwise rotation of the remote control to a reduction in size of the displayed image information.

If a sequence of four-dimensional (4D) images is present, then one translatory movement can, in turn, for example, be converted into a change in the displayed image section. A rotational movement of the remote control can result in selection of the previous or following image, depending on the direction of rotation.

In one embodiment, a display mode permits the operation of a processing unit implemented as a workstation computer by the user movement in the manner of a computer mouse. One or more additional operator buttons may be arranged on the remote control. When such an operator button is actuated, in particular an actuation of the left or the right mouse button of a computer mouse is emulated. A double-click, as is normally executed with the left mouse button for starting programs or the like, may be replicated by actuating an operator button twice in immediate succession. It is possible to remotely control the workstation computer by the remote control without needing to change its location for this purpose.

The communication interface between the remote control and the computer system may be designed in such a manner that it corresponds to the standard interface of a computer mouse in respect of the control signals sent to the computer system. Software modules installed on the operating system of the computer system can be used in the usual manner in their full functional scope. Adaptation or reprogramming of the software modules, in conjunction with corresponding programming costs, is not required.

Since the software module provided for displaying the image information is normally provided for operation by a computer mouse, complete operation of the software module is also possible with the remote control. By using the remote control in the manner of a computer mouse the user may, for example, select an image section. With the display modes already described, a change in the displayed image information can subsequently be made through a translatory movement or through a rotational movement of the remote control. The image information displayed on the display element can also be changed through the successive use of a plurality of display modes.

The user movement may be registered iteratively over a predefined time interval and averaged over this time interval. Abrupt and vigorous movements of the remote control are moderated.

The user movement may only be converted into a virtual movement when it exceeds a predefined threshold. The situation is avoided whereby in the case of only a slight displacement of the remote control a change immediately takes place in the displayed image information.

A medical diagnostic or therapeutic unit may include a device for displaying a three-dimensional image. The embodiments based on the device for displaying a three-dimensional image, and their advantages, are to be applied by analogy to the medical diagnostic or therapeutic unit.

### BRIEF DESCRIPTION OF THE DRAWINGS

FIG. 1 shows a device for displaying a three-dimensional medical image in a schematic representation,

FIG. 2 shows a first operating mode of the device,

FIG. 3 shows a second operating mode of the device, and

FIG. 4 shows a third operating mode of the device.

### DETAILED DESCRIPTION

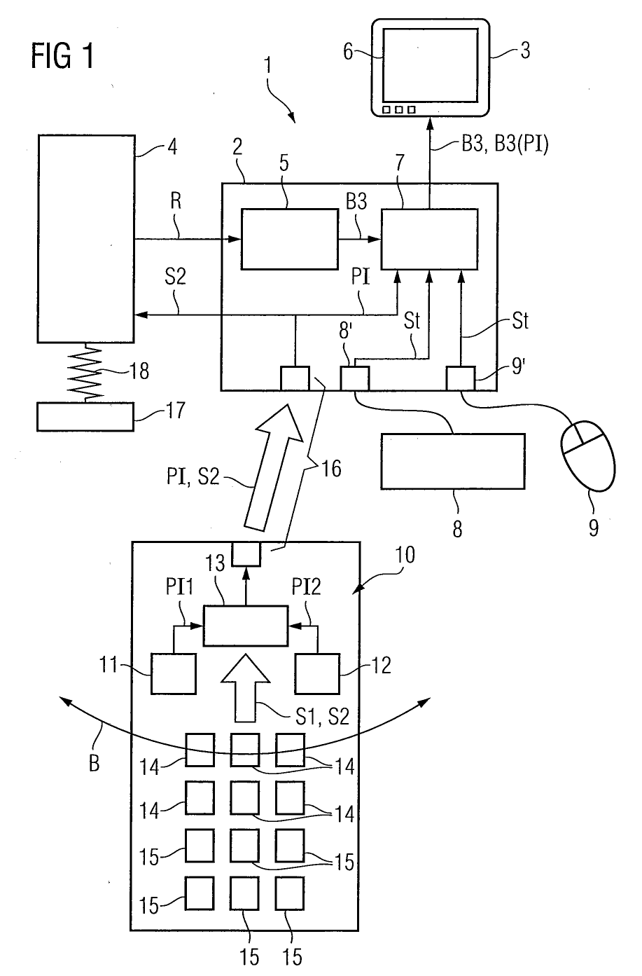

FIG. 1 shows a device for displaying a three-dimensional medical image 1 with a processing unit 2 taking the form of a computer system and with a display element 3 connected to the processing unit and taking the form of a monitor. The device 1 is associated with a medical imaging system 4 which takes the form, for example, of a computer tomograph (CT), a positron emission tomograph (PET), a single photon emission computed tomograph (SPECT) or a magnetic resonance tomograph (MRT). The medical imaging system 4 raw data R is measured. The raw data R is processed by an arithmetic unit 5 associated with the processing unit 2. A three-dimensional medical image B3 is computed and displayed on a display 6 of the display element 3. In the case of a computer tomograph, projection images are measured as raw data R, which is converted by an arithmetic unit 5, taking the form of a reconstruction computer into a three-dimensional medical image B3. A software module 7 is provided for the preparation of the image information B3. A computer keyboard 8 and a computer mouse 9 are connected to the processing unit 2 as control elements by a respective interface 8′, 9′.The control elements 8, 9 may control access by control signals St to the software module 7. The image information B3 is prepared by a user interface. The image information B3 displayed on the display 6 can be changed. As a result, it is possible to enlarge a section of the image B3 and to move this section by the cursor keys on the computer keyboard 8 or by means of scrolling with the computer mouse 9. Similarly, the displayed image B3 may be rotated or tilted.

A remote control 10 is associated with the device 1. The remote control 10 comprises a three-axis acceleration sensor 11 and a three-axis rotary rate sensor 12. Any user movement B of the remote control 10 may be registered by the two sensors 11, 12. Position information PI1 is measured by the acceleration sensor and position information PI2 is measured by the rotary rate sensor 12. Position information PI1 and PI2 are sent to a processing unit 13. A number of display selection switches 14 are provided whose switching states S1 are passed to the processing unit 13. A number of control selection switches 15 are provided whose switching states S2 are passed to the processing unit 13. Depending on the switching state S1 of the display selection switch 14, the processing unit 13 prepares the position information PI1, PI2 measured by the sensors 11, 12 and passes this as position information PI using a communication interface 16 to the processing unit 2. The position information PI is processed by the software module 7 with the image information B3 in such a manner that the user movement B is reproduced as a virtual movement of the displayed image information B3(PI). The user movement B of the remote control 10 is reproduced on the basis of the displayed image B3(PI). As a result, intuitive changing of the displayed image information B3(PI) is provided.

The switching states S2 of the control selection switch 15 are passed from the processing unit 13, by way of the communication interface 16, to the processing unit 2 and from there to the medical imaging system 4. Depending on the implementation of the medical imaging system 4, device functions may be controlled remotely by the remote control 10. For example, by using the remote control 10 in the case of a computer tomography, a scan may be initiated in order to produce new raw data R and a new three-dimensional medical image B3. If the medical imaging system is part of a medical therapeutic facility, then provision can be made to turn a particle beam for beam therapy on or off by means of the control selection switch 15.

A holding device 17 for the remote control 10 is associated with the medical imaging system 4. The holding device 17 may include an elastic mounting 18, a spring arm, or similar support, for example, by which the holding device 17 is attached to a component of the imaging system 4. The component of the imaging system 4, for example, may be a rail of a patient examination table.

In one summarizing example, an attending doctor may, from any desired location, both initiate functions of the imaging system 4 and also make a change to the displayed image information B3(PI). The attending doctor does not need to go to the processing unit 2 and use the computer keyboard 8 or the computer mouse 9 there to initiate functions locally. Rather, the attending doctor can concentrate fully on his medical task, performing a medical intervention, for example. If required, a new measurement is initiated the medical imaging system 4 to produce a new image B3 in order to control the progress of the medical intervention. The image information B3(PI) displayed on the display 6 is modified by the remote control in order to enable an optimum interpretation. The medical intervention is then continued depending on the result of this interpretation.

When the remote control 10 is not required, the remote control 10 may be placed into the holding device 17. By using the elastic mounting 18 of the holding device 17, the attending doctor is able to perform user movements B which are converted into a virtual movement of the image B3(PI), albeit with a possibly restricted movement capability.

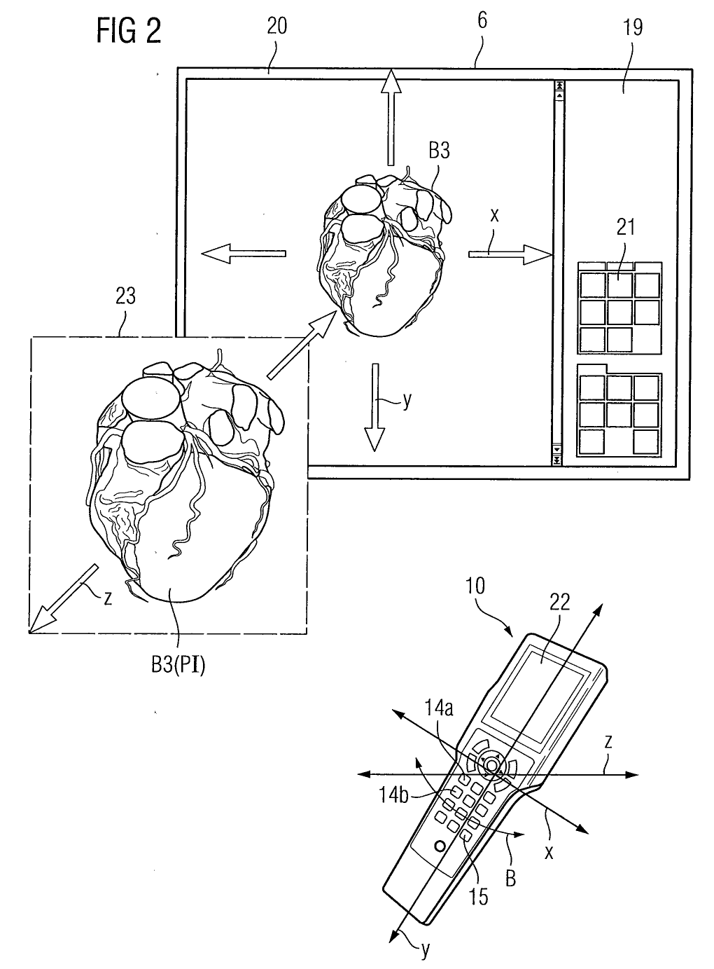

FIG. 2 shows the display 6 of the display element 3, on which a user interface 19 is displayed. The user interface 19 has a menu bar 20 and a number of buttons 21, by which functions of the software module 7 can be accessed. The user interface 19 is operated at the location of the display element 3 by the computer keyboard 8 or the computer mouse 9 by accessing the menu bar 20 or the buttons 21. The displayed image information may be changed from the location of the computer keyboard 8 or of the computer mouse 9.

The software module 7 is accessed by the remote control 10. The remote control 10 has a display panel 22 for displaying a currently selected operating mode. A first display mode is selected by actuating the display selection switch 14a and a section 23 of the image information B3 is displayed on the display 6. A user movement B of the remote control 10 the section can then be displaced until such time as the displayed image information B3(PI) displays the desired section 23. The first display mode has the function merely of evaluating the translatory movement of the remote control 10 in all three spatial directions x, y, z measured by the acceleration sensor 11 and converting it into a displacement of the section 23 in all three spatial directions x, y, z for displaying the image information B3(PI). When the display selection switch 14a is actuated repeatedly in succession, the section 23 may be enlarged stepwise. A further display selection switch 14b the originally displayed image information B3 may be restored again and the first display mode exited again.

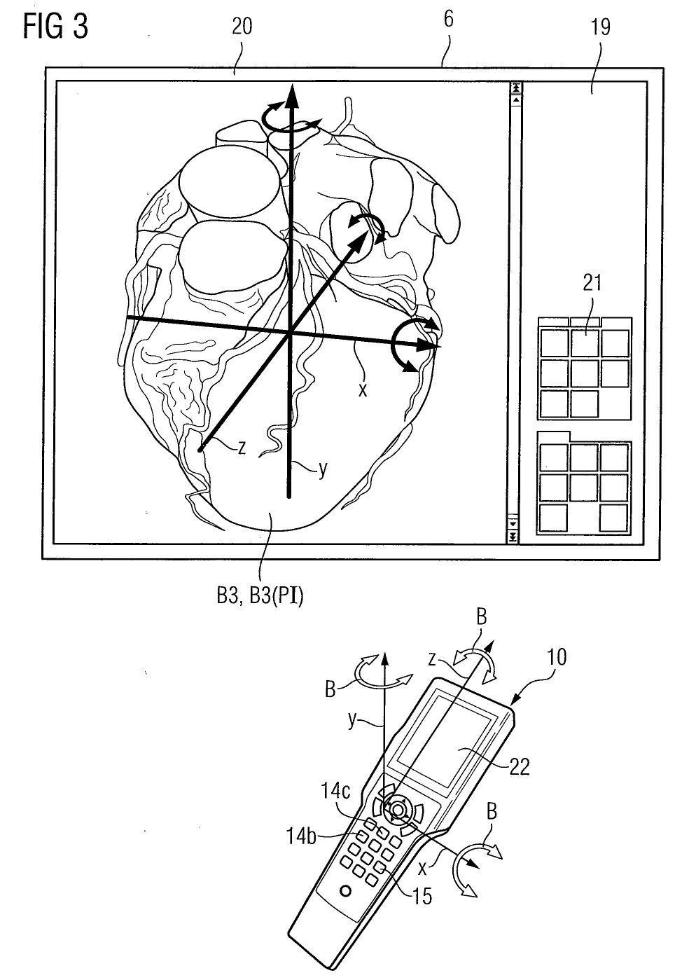

FIG. 3 shows the display 6 of the display element 3 with a heart as the three-dimensional image information B3 represented. A display selection switch 14b on the remote control 10 a second display mode of the remote control 10 may be selected. When the second display mode is selected, only rotational movements of the remote control 10 and only the measurement signal from the rotary rate sensor 12 of the remote control 10 are evaluated as a user movement B and converted into a turning or rotation of the displayed image information B3(PI). Any turning or rotation motions around the three spatial axes x, y, z can be registered as a user movement B. By turning the remote control 10 in all three spatial directions the image information B3 may be rotated until such time as the image information B3(PI) of interest to the user is displayed on the display 6. The original image information B3 is displayed again by actuating the display selection switch 14c and the second operating mode of the remote control 10 is exited.

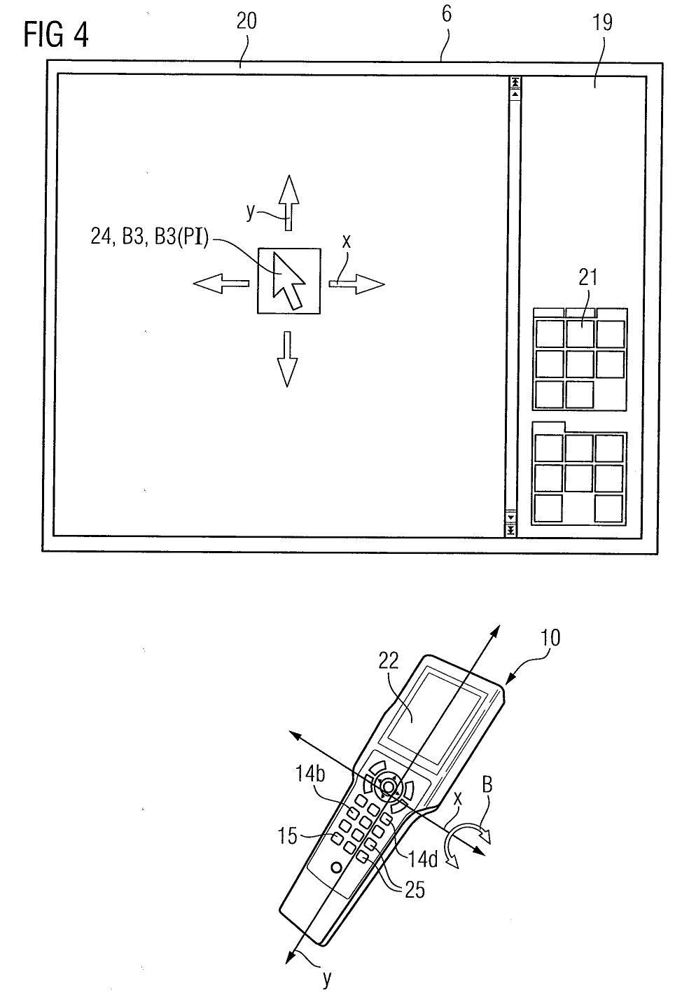

FIG. 4 shows the display 6 in a third display mode which has been selected by actuating the display selection switch 14d. There is no longer any image information B3 to be seen on the display 6. A mouse cursor 24 is now displayed, which can be used by the remote control 10 to select any desired program functions by the user interface 19. The third display mode corresponds to operation of the user interface 19 in the manner of the computer mouse 9. The position information PI1 measured by using the acceleration sensor 11 is processed in such a manner that a movement in the direction of two spatial axes x, y is evaluated as a user movement B and is converted into the position information PI. The third spatial direction on the other hand is not utilized for the movement of the mouse cursor 24. The virtual movement of the displayed image information B3(PI) may correspond to the movement of the mouse cursor 24. Two operator buttons 25 are provided whose functions correspond to a left and a right mouse button. The remote control 10 may reproduce all the functions of a computer mouse.

The third display mode is exited again by renewed actuation of the display selection switch 14d.

Various embodiments described herein can be used alone or in combination with one another. The forgoing detailed description has described only a few of the many possible implementations of the present invention. For this reason, this detailed description is intended by way of illustration, and not by way of limitation. It is only the following claims, including all equivalents that are intended to define the scope of this invention.

1. A device for displaying a medical image, the device comprising:
a processing unit for processing medical image information,
a display for displaying the medical image information,
a remote control for registering a user movement by at least one motion-sensitive sensor,
a communication interface for transferring the user movement to the processing unit, and
a software module associated with the processing unit for reconciling the user movement with the medical image information so that the user movement is reproduced as a virtual movement of the displayed medical image information.

2. The device as claimed in claim 1, where the medical image information is a three-dimensional image.

3. The device as claimed in claim 1, where the at least one motion-sensitive sensor is an acceleration sensor with one or more measuring axes.

4. The device as claimed in claim 1, where the at least one motion-sensitive sensor is a rotary rate sensor with one or more measuring axes.

5. The device as claimed in claim 1, where the remote control has at least one acceleration sensor and at least one rotary rate sensor.

6. The device as claimed in claim 1, where a radio link is provided as a communication interface.

7. The device as claimed in claim 1, where the remote control has a number of display selection switches for selecting a display mode in each case and where the conversion of the user movement into the virtual movement of the image takes place depending on the display mode selected.

8. The device as claimed in claim 7, where the remote control has at least one control selection switch for remotely controlling a medical diagnostic or therapeutic unit.

9. The device as claimed in claim 1, where a holding device is provided for holding the remote control in a rest position.

10. The device as claimed in claim 9, where the holding device has an elastic mounting.

11. A method for displaying a medical image, the method comprising:
registering a user movement with a remote control by at least one motion-sensitive sensor; and
reproducing the user movement as a virtual movement of displayed medical image information.

12. The method as claimed in claim 11, further comprising measuring the user movement using a single- or multiple-axis acceleration sensor.

13. The method as claimed in claim 11, further comprising measuring the user movement using a single- or multiple-axis rotary rate sensor.

14. The method as claimed in claim 11, further comprising measuring the user movement using at least one acceleration sensor and at least one rotary rate sensor.

15. The method as claimed in claim 11, further comprising transferring user movement data using a radio link.

16. The method as claimed in claim 11, further comprising selecting a display mode, the conversion of the user movement into the virtual movement of the image takes place depending on the selected display mode.

17. The method as claimed in claim 16, where the display mode provides for a selection and displacement of an enlarged image section in at least one spatial direction.

18. The method as claimed in claim 16, where the display mode provides for a rotation of the displayed image information around at least one spatial axis.

19. The method as claimed in claim 16, where the display mode provides for a change in the scale of the displayed image information.

20. The method as claimed in claim 16, where the display mode provides for a change in contrast of the displayed image information.

21. The method as claimed in claim 16, where the display mode utilizes the measurements taken with the acceleration sensor and with the rotary rate sensor jointly in order to change the displayed image information.

22. The method as claimed in claim 16, where the display mode permits the operation of a processing unit implemented as a workstation computer by the user movement of a computer mouse.

23. The method as claimed in claim 16, where registering the user movement includes registering the user movement iteratively over a predefined time interval.

24. The method as claimed in claim 16, where the virtual movement only takes place when the user movement exceeds a predefined threshold.
